(19) United States
(12) Patent Application Publication
(10) Pub. No.: US 2015/0306845 A1
(43) Pub. Date: Oct. 29, 2015

(54) LAMINATION MADE OF RIGID SUBSTRATES WITH THIN ADHESIVE STRIPS

(71) Applicant: TESA SE, Hamburg (DE)

(72) Inventors: Thilo DOLLASE, Hamburg (DE); Thorsten KRAWINKEL, Hamburg (DE); Lesmona SCHERF, Hamburg (DE); Minyoung BAI, Hamburg (DE)

(73) Assignee: TESA SE, Hamburg (DE)

(21) Appl. No.: 14/648,069

(22) PCT Filed: Nov. 25, 2013
(86) PCT No.: PCT/EP2013/074595

§ 371 Date: May 28, 2015

(30) Foreign Application Priority Data
Dec. 3, 2012 (DE) 10 2012 222 056.9

(51) Int. Cl. B32B 7/12; C08J 5/12; C09J 7/02; B32B 37/12; B32B 27/22

(52) U.S. Cl. CPC B32B 7/12; B32B 37/12; B32B 27/22; C09J 7/02; C08J 5/124; B32B 2305/72; C09J 153/00

(57) ABSTRACT

A laminate made of two rigid substrates and an adhesive film arranged between them, at least one of the substrates being transparent, the thickness of the adhesive film being not greater than 80 μm and the adhesive film comprising at least one adhesive layer made of an adhesive compound to which one or more plasticizers are added, at least one of which is a reactive plasticizer.

This is a 371 of PCT/EP2013/074595 filed 25 Nov. 2013, which claims foreign priority benefit under 35 U.S.C. 119 of German Patent Application 10 2012 222 056.9 filed Dec. 3, 2012, the entire contents of which are incorporated herein by reference.

### BACKGROUND OF THE INVENTION

The invention relates to a laminate of two rigid substrates and an adhesive film for joining these substrates to one another, and also to a process for producing such substrates.

A particular challenge in the field of the adhesive bonding of two components is posed by the lamination of two rigid substrates. Especially in areas requiring laminates possessing very high optical quality, the combination of known adhesive systems and laminating operations is often unsuccessful. Applications in these areas such as glass bonding or else the production of solar modules, and especially display technology, are part of markets which are currently experiencing strong growth.

Common adhesive systems for the bonding of two rigid substrates are liquid adhesives, double-sided self-adhesive tapes, especially those without carriers, known as adhesive transfer tapes, and hotmelt adhesive films. In customary bonding operations, an adhesive film is first applied to a first rigid substrate. Although even this step requires in-depth technology experience, there are now a range of adhesive films and laminating processes available. Subsequently, however, this initial product, consisting of the first rigid substrate and of the adhesive film, must be bonded with the second rigid substrate. This requires specific laminating processes, and many adhesive systems are unsuitable for realization of high-quality laminating outcomes. The difficulty is generally perceived as being the presence in the bond plane of air inclusions, which cannot be eliminated subsequently even by aftertreatment such as autoclaving (treating the laminate at elevated pressure and elevated temperature). Whereas laminators are available commercially, users are required to have recourse to very specific adhesive systems in order successfully to carry out a laminating operation of two rigid substrates. The existing adhesive systems all have individual drawbacks, and so there is a need for new systems. Liquid adhesives have drawbacks in terms of occupational safety, odor nuisance, and cleanliness in processing. Double-sided self-adhesive tapes require a thick layer for a high-quality laminating outcome. As part of continual reduction in dimensions of components and devices, the desire is for thin adhesive layers. Hotmelt adhesive films customarily require high laminating temperatures, a regime intolerable for heat-sensitive substrates.

The search is therefore on for bonding solutions for the laminating of two rigid substrates at no more than moderately increased laminating temperature, using a bonding means which is distinguished by low layer thickness and good handling qualities.

U.S. Pat. No. 4,599,274 to Denki Kagaku discloses liquid adhesives for the bonding of two rigid substrates. While the laminating can be performed successfully and even for thin applied adhesive layers, the metering of the liquid adhesives may nevertheless be difficult, and the handling qualities of such systems in particular are a drawback. Noted in particular may be the squeezing-out of the low-viscosity liquid adhesive, leading to soiling in the periphery of the components, and odor nuisance and in some cases adverse health effects on the operatives, as a result of low molecular mass constituents.

Laminated safety glass, consisting of two rigid glass plies laminated together, is nowadays typically bonded using polyvinyl butyral films which are amenable to hot lamination. Commercial films are available, for example, from Kuraray, and for this application have layer thicknesses from 100 μm up to 1 mm. According to product information (http://www.trosifol.com/vsg-herstellung/herstellung-vsg-architektur/), lamination takes place at around 140° C.

US 2010/129665 A1 to DuPont describes hotmelt-processable adhesive films in laminating operations. Two rigid substrates are bonded under reduced pressure and at elevated temperature. The bonding temperature is above the softening temperature of the hotmelt adhesive and for the ethylene copolymers described is 140° C. These conditions cannot be employed with heat-sensitive substrates such as many plastics, many coated or printed glasses, or substrates which carry sensitive organic electronics (e.g., LCDs or OLEDs).

JP 2008-009225 to Optrex describes optically clear adhesive transfer tapes for the bonding of rigid touch panels to rigid LCD displays. The adhesive transfer tapes have a layer thickness of at least 100 μm.

A similar teaching is that of U.S. Pat. No. 7,566,254 to Rockwell. There, two rigid substrates are bonded using adhesive transfer tapes having a layer thickness of 125 μm.

A high layer thickness on the part of the laminating adhesive inevitably leads to an increase in component size, this being an undesirable development in the course of continual reduction in the formats, for example, of consumer electronic devices (cell phones, tablet PCs).

U.S. Pat. No. 7,655,283 B2 to 3M describes double-sided adhesive tapes for the lamination of two rigid substrates. Stated explicitly is a 50 μm polyester film which on one side carries a 25 μm OCA adhesive (not in accordance with the invention) and on the other a 25 μm adhesive which is inventive in the sense of the US specification. This latter adhesive is based on a silicone network that includes a high fraction of silicone-based plasticizer. Silicone-containing formulations, and especially silicone-based plasticizers, harbor the risk that they may migrate from the bondline into other contact areas, where they may possibly result in adverse effects on bond strengths.

U.S. Pat. No. 7,655,283 also describes a process allowing lamination of two rigid substrates by means of silicone-containing formulations. In this regard there is disclosure to the effect that the particular feature of the adhesive formulation is that lamination takes place without additional pressure, merely by the effect of gravitation. According to the description, applying pressure by finger or by a roller is not carried out for the rigid/rigid lamination. The process of development of adhesion is therefore a slow one, and it is questionable whether it can be integrated easily into automated and/or machine processes for the purpose of increased throughput and reproducibility.

The desire is therefore for a silicone-free adhesive film with low thickness that can be used to laminate two rigid substrates with high optical quality (substantially bubble-free) at room temperature or at most slightly elevated temperature.

There is also a desire for a laminating process which can be automated, more particularly a machine-based laminating process, which allows the bonding of two rigid substrates in high optical quality (substantially bubble-free) at room temperature or at most slightly elevated temperature, using an adhesive film whose thickness is low.

### SUMMARY OF THE INVENTION

The object is achieved by means of an adhesive film having a thickness of not more than 80 μm, preferably not more than 60 μm, which comprises at least one adhesive layer composed of an adhesive admixed with one or more plasticizers of which at least one is a reactive plasticizer, the plasticizer fraction in the adhesive being in total at least 15 wt % and the fraction of reactive plasticizer in the adhesive being at least 5 wt %.

The invention accordingly relates to a laminate of two rigid substrates and an interposed adhesive film, the adhesive film being a film as specified above. In particular, one of the rigid substrates is transparent, preferably both substrates.

Transparent substrates for the purposes of this specification have a haze value of at most 50%; preferably, the transparent substrates have a haze value of not more than 10%, very preferably of not more than 5% (measured according to ASTM D 1003).

### DETAILED DESCRIPTION

### Brief Description of the Drawings

FIG. 1 illustrates a laminate assessed as having air inclusions

FIG. 2 illustrates a laminate assessed as bubble-free

Rigid substrates for the purposes of this specification are for example substrates—more particularly sheetlike substrates—of glass, of metal, of ceramic, or of other materials having an elasticity modulus (DIN EN ISO 527) of more than 10 GPa, preferably of more than 50 GPa, the aforementioned substrates having in particular a thickness of at least 500 μm, but also sheetlike substrates composed of plastics such as polyesters (PE), polymethyl methacrylate (PMMA), polycarbonate (PC), of acrylonitrile-butadiene-styrene copolymers (ABS), or of other materials having an elasticity modulus of at least 1 GPa but not more than 10 GPa, the plastics substrates and substrates of materials having an elasticity modulus of at least 1 GPa but not more than 10 GPa having in particular a thickness of at least 1 mm. Customarily the sheetlike substrates are also used with a higher thickness, for instance 2 mm or more.

The substrates used are considered to be rigid especially when the product of thickness and elasticity modulus is at least 500 N/mm. Particular preference is given to using substrates for which the product of thickness and elasticity modulus is at least 2500 N/mm, more preferably 5000 N/mm. The more rigid the substrates used, the greater the difficulty of bubble-free lamination with a very thin adhesive tape. The teaching of the invention has nevertheless resulted in success even for the lamination of rigid substrates of the kind described above.

The optically high-quality bonding of the adhesive film with the substrates produces a product which can be used even for optically demanding fields of application, such as the bonding of transparent windows (such as glass) in the electronics sector, such as for displays, for example.

The adhesive film may be single-layer or multilayer, as for instance three-layer. In the first case, the adhesive film consists of the plasticizer-containing adhesive layer. A three-layer adhesive film may consist, for example, of a carrier layer and two adhesive layers, of which at least one is plasticizer-containing in the manner described above, this preferably being true of both adhesive layers. With particular preference, three-layer adhesive films are constructed symmetrically in terms of the composition of the adhesive layers.

At least one of the adhesive layers consists preferably of an adhesive characterized by a complex viscosity at laminating temperature according to test 1 (DMA at 10 rad/s; test 1) of greater than 2000 Pa s, preferably of greater than 5000 Pa s, and of less than 10 000 Pa s, preferably of less than 8000 Pa s, and by a complex viscosity at autoclaving temperature according to test 1 of greater than 500 Pa s, preferably of greater than 2000 Pa s, and of less than 7000 Pa s, preferably of less than 5000 Pa s. The plasticity is achieved by the adhesive formulation comprising a plasticizer, more particularly silicone-free and very preferably a silicone-free reactive plasticizer. Plasticizers are present in the formula at not less than 15%, preferably not less than 20%, and at not more than 40%, preferably not more than 35%. At least 5 wt %, based on the adhesive, is reactive plasticizers. Where only one plasticizer is added, it is the reactive plasticizer. Where two or more plasticizers are present, they may—within the specified limits—be reactive plasticizers as well as nonreactive plasticizers, or exclusively reactive plasticizers.

The reactive plasticizer can be cured to result in the attainment of a high ultimate strength on the part of the adhesive bond.

In one preferred embodiment, therefore, the adhesive film of the laminate of the invention is cured at a time after lamination, in particular through curing of the plasticizer-containing adhesive layer by means of the reactive plasticizer.

The solution further proposes a process for the adhesive bonding of two rigid substrates using an adhesive film as set out above, comprising two laminating steps and optionally an autoclaving step.

Here, in particular, in the first process step, the adhesive film is laminated onto one of the two rigid substrates, and in the second laminating step the assembly thus produced, composed of first substrate and adhesive film, is laminated together by the adhesive film side to the other rigid substrate, the second laminating step being carried out at not more than 50° C., preferably at not more than 30° C., and the thickness of the adhesive film being not more than 80 μm, and the adhesive film comprising at least one adhesive layer of an adhesive admixed with one or more plasticizers of which at least one is a reactive plasticizer, and the plasticizer fraction in the adhesive being in total at least 15 wt % and the fraction of reactive plasticizer in the adhesive being at least 5 wt %.

The two laminating steps 1 and 2 are carried out preferably at not more than 50° C., preferably at not more than 30° C.

Very preferably the second laminating step, more particularly both laminating steps, are carried out without active heating, in other words in particular at room temperature (23° C.).

The optional autoclaving step is carried out preferably at not more than 75° C. (especially in the case of temperature-sensitive substrates), preferably at not more than 60° C. The pressure is preferably not more than 6 bar. The autoclaving temperature, if that step is selected, is preferably at least 10° C. above the laminating temperature especially of the second laminating step, preferably at least 20° C. above the laminating temperature especially of the second laminating step.

The reactive plasticizer is more particularly a plasticizer which can be cured. This is done during and/or after laminating step 2 and/or during and/or after the autoclaving step.

The laminates of the invention are very preferably produced in such a way that for the adhesive film itself and/or during the production of the laminate, at least one of the following conditions is met, preferably two or more of the following conditions being met, and more particularly all of the following conditions being met:

| | |
|---|---|
| Plasticizer fraction | at least 15%, preferably at least 20%, at |
| | most 40%, preferably at most 35% |
| Complex viscosity at laminating | >2000 Pa s, preferably >5000 Pa s and |
| temperature | <10 000 Pa s, preferably <8000 Pa s |
| Complex viscosity at | >500 Pa s, preferably >2000 Pa s and |
| autoclaving temperature | <7000 Pa s, preferably <5000 Pa s |
| Thickness of double-sided | max. 80 μm, preferably max. 60 μm |
| adhesive product | |

### Layer of Adhesive of the Invention:

The adhesive layer consists advantageously of a pressure sensitive adhesive (PSA) formulation. PSAs which can be employed include more particularly all polymers of linear, star-shaped, branched, grafted, or other architecture, preferably homopolymers, random copolymers, or block copolymers, which have a molar mass of at least 50 000 g/mol, preferably of at least 100 000 g/mol, very preferably of at least 250 000 g/mol. Preference is also given to at least a softening temperature of less than 0° C., more particularly of less than −30° C. The molar mass in this context means the weight average of the molar mass distribution as obtainable for example via gel permeation chromatography analyses. Softening temperature in this context is understood to be the quasistatic glass transition temperature for amorphous systems, and the melting temperature for semicrystalline systems, that may be determined for example by dynamic scanning calorimetry measurements. Where numerical values are reported for softening temperatures, they relate to the mid-point temperature of the glass stage in the case of amorphous systems, and to the temperature at maximum heat change during the phase transition in the case of semicrystalline systems.

(Result of measurements by dynamic scanning calorimetry, DSC, in accordance with DIN 53 765; especially sections 7.1 and 8.1, but with uniform heating and cooling rates of 10 K/min in all heating and cooling steps (cf. DIN 53 765; section 7.1; note 1). The initial sample mass is 20 mg. The PSA is pretreated (cf. section 7.1, first run). Temperature limits: −140° C. (instead of T_{g}−50° C.)/+200° C. (instead of T_{g}+50° C.).)

PSAs which can be used are all of the PSAs known to the skilled person, especially acrylate-, natural rubber-, synthetic rubber-, or ethylene-vinyl acetate-based systems. Combinations of these systems can be used in accordance with the invention as well. As examples, but without wishing to impose any restriction, mention may be made, as being advantageous in the sense of this invention, of random copolymers starting from unfunctionalized α,β-unsaturated esters, and random copolymers starting from unfunctionalized alkyl vinyl ethers. Preference is given to using α,β-unsaturated alkyl esters of the general structure

CH₂═C(R¹)(COOR²) (I)

where R¹ is H or CH₃ and R² is H or linear, branched or cyclic, saturated or unsaturated alkyl radicals having 1 to 30, more particularly having 4 to 18, carbon atoms. Monomers which are used very preferably in the sense of the general structure (I) comprise acrylic and methacrylic esters with alkyl groups consisting of 4 to 18 C atoms. Specific examples of such compounds, without wishing to suffer any restriction as a result of this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, the branched isomers thereof, such as 2-ethylhexyl acrylate and isooctyl acrylate, for example, and also cyclic monomers such as cyclohexyl or norbornyl acrylate and isobornyl acrylate, for example. Likewise possible for use as monomers are acrylic and methacrylic esters which contain aromatic radicals, such as phenyl acrylate, benzyl acrylate, benzoin acrylate, phenyl methacrylate, benzyl methacrylate, or benzoin methacrylate, for example. Additionally it is possible optionally to use vinyl monomers from the following groups: vinyl esters, vinyl ethers, vinyl halides, vinylidene halides, and also vinyl compounds which contain aromatic rings or heterocycles in α-position. For the vinyl monomers optionally employable, mention may be made, by way of example, of selected monomers useful in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene, and α-methylstyrene. Other monomers which can be used in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acrylic acid, methacrylic acid, itaconic acid and the esters thereof, crotonic acid and the esters thereof, maleic acid and the esters thereof, fumaric acid and the esters thereof, maleic anhydride, methacrylamide and also N-alkylated derivatives, acrylamide and also N-alkylated derivatives, N-methylolmethacrylamide, N-methylolacrylamide, vinyl alcohol, 2-hydroxyethyl vinyl ether, 3-hydroxypropyl vinyl ether, and 4-hydroxybutyl vinyl ether.

In the case of rubber or synthetic rubber as starting material for the PSA, there are further possible variations, whether from the group of the natural rubbers or synthetic rubbers or whether from any desired blend of natural rubbers and/or synthetic rubbers, with the natural rubber or rubbers being selectable in principle from all available grades such as, for example, crepe, RSS, ADS, TSR or CV products, according to required level of purity and viscosity, and the synthetic rubber or rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene vinyl acetate copolymers (EVA) and polyurethanes and/or blends thereof. Furthermore, rubbers may be admixed, for the purpose of improving the processing properties, with preferably thermoplastic elastomers, with a weight fraction of 10 to 50 wt %, based on the total elastomer fraction. As representatives, mention may be made at this point in particular of the especially compatible types polystyrene-polyisoprene-polystyrene (SIS) and polystyrene-polybutadiene-polystyrene (SBS). Likewise possible for advantageous use as base materials for adhesive layers are block copolymers. In these products, individual polymer blocks are linked covalently to one another. The blockwise linkage may be present in a linear form, or else in a star-shaped or graft copolymer variant. One example of a block copolymer which can be used advantageously is a linear triblock copolymer whose two terminal blocks have a softening temperature of at least 40° C., preferably at least 70° C., and whose middle block has a softening temperature of not more than 0° C., preferably not more than −30° C. Higher block copolymers, tetrablock copolymers for instance, can likewise be used. It may be opportune for the block copolymer to comprise at least two polymer blocks of the same or different kind, which have a softening temperature in each case of at least 40° C., preferably at least 70° C., and which are separated from one another in the polymer chain by at least one polymer block having a softening temperature of at most 0° C., preferably at most −30° C. Examples of polymer blocks are polyethers such as, for example, polyethylene glycol, polypropylene glycol or polytetrahydrofuran, polydienes, such as polybutadiene or polyisoprene, hydrogenated polydienes, such as polyethylene-butylene or polyethylene-propylene, polybutylene or polyisobutylene, polyesters, such as polyethylene terephthalate, polybutanediol adipate or polyhexanediol adipate, polycarbonate, polycaprolactone, polymer blocks of vinylaromatic monomers, such as polystyrene or poly-α-methylstyrene, polyalkyl vinyl ethers, polyvinyl acetate, polymer blocks of α,β-unsaturated esters such as, in particular, acrylates or methacrylates, for example. The skilled person is aware of corresponding softening temperatures. Alternatively the skilled person looks them up, for example, in the Polymer Handbook [J. Brandrup, E. H. Immergut, E. A. Grulke (eds.), Polymer Handbook, 4th edn. 1999, Wiley, New York]. Polymer blocks may be constructed of copolymers.

Tackifying resins which can be optionally employed include without exception all tackifier resins already known and described in the literature. Representatives that may be mentioned include the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to bring the properties of the resultant adhesive into line with the requirements. Depending on their composition, however, the adhesives may also be used in resin-free form.

For the purpose of adjusting the laminating properties, the adhesive of the invention comprises at least one kind of plasticizer. For this purpose it is possible to use all plasticizing substances known from self-adhesive technology. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates.

At least one of the plasticizers used is a reactive plasticizer. As reactive plasticizers it is possible to use all known reactive resins and reactive resin mixtures which are liquid at laminating temperature. Suitable reactive resins are those which are curable thermally and/or radiatively. Very preferably they are further admixed with suitable thermally and/or photochemically activatable initiators.

Very preferred as reactive systems are (meth)acrylate resins and/or (meth)acrylate resin mixtures, which in combination with photoinitiators may be cured UV-radically.

The adhesive of the invention accordingly comprises as reactive plasticizers very preferably at least one kind of reactive resin based on an acrylate or methacrylate for the radiative and optionally thermal crosslinking, with a softening temperature below the laminating temperature. The reactive resins based on acrylates or methacrylates are more particularly aromatic or, especially, aliphatic or cycloaliphatic acrylates or methacrylates.

Suitable reactive resins carry at least one (meth)acrylate function, preferably at least two (meth)acrylate functions. Further compounds with at least one (meth)acrylate function, preferably of higher (meth)acrylate functionality, can be used for the purposes of this invention.

Where compounds are employed which carry only one (meth)acrylate function, preference is given in the sense of this invention to using (meth)acrylate reactive resins which conform to the general structural formula (I).

CH₂═C(R¹)(COOR²) (I)

In structure (I), R¹ denotes H or CH₃ and R² denotes linear, branched or cyclic, aliphatic or aromatic hydrocarbon radicals having 1 to 30 C atoms.

Reactive resins which are used very preferably in the sense of general structure (I) encompass acrylic and methacrylic esters with alkyl groups consisting of 4 to 18 C atoms. Specific examples of such compounds, without wishing this enumeration to impose any restriction, are n-butyl acrylate, n-butyl methacrylate, n-pentyl acrylate, n-pentyl methacrylate, n-hexyl acrylate, n-hexyl methacrylate, n-heptyl acrylate, n-heptyl methacrylate, n-octyl acrylate, n-octyl methacrylate, n-nonyl acrylate, n-nonyl methacrylate, lauryl acrylate, lauryl methacrylate, hexadecyl acrylate, hexadecyl methacrylate, stearyl acrylate, stearyl methacrylate, behenyl acrylate, behenyl methacrylate, branched isomers thereof such as, for example, 2-ethylhexyl acrylate, 2-ethylhexyl methacrylate, isooctyl acrylate, isooctyl methacrylate, isodecyl acrylate, isodecyl methacrylate, tridecyl acrylate, tridecyl methacrylate, and also cyclic monomers such as, for example cyclohexyl acrylate, cyclohexyl methacrylate, tetrahydrofurfuryl acrylate, tetrahydrofurfuryl methacrylate, dihydrodicyclopentadienyl acrylate, dihydrodicyclopentadienyl methacrylate, 4-tert-butylcyclohexyl acrylate, 4-tert-butylcyclohexyl methacrylate, norbornyl acrylate, norbornyl methacrylate, isobornyl acrylate, and isobornyl methacrylate.

It is additionally possible to use acryloylmorpholine, methacryloylmorpholine, trimethylolpropane formal monoacrylate, trimethylolpropane formal monomethacrylate, propoxylated neopentyl methyl ether monoacrylate, propoxylated neopentyl methyl ether monomethacrylate, tripropylene glycol methyl ether monoacrylate, tripropylene glycol methyl ether monomethacrylate, ethoxylated ethyl acrylate such as ethyldiglycol acrylate, ethoxylated ethyl methacrylate such as ethyldiglycol methacrylate, propoxylated propyl acrylate, and propoxylated propyl methacrylate.

Likewise employable as reactive resins are acrylic and methacrylic esters which contain aromatic radicals, such as, for example, phenyl acrylate, benzyl acrylate, phenyl methacrylate, benzyl methacrylate, phenoxyethyl acrylate, phenoxyethyl methacrylate, ethoxylated phenol acrylate, ethoxylated phenol methacrylate, ethoxylated nonylphenol acrylate, or ethoxylated nonylphenyol methacrylate.

Additionally it is possible to use aliphatic or aromatic, especially ethoxylated or propoxylated, polyether mono(meth)acrylates, aliphatic or aromatic polyester mono(meth)acrylates, aliphatic or aromatic urethane mono(meth)acrylates, or aliphatic or aromatic epoxy mono(meth)acrylates, as compounds which carry a (meth)acrylate function.

As compounds which carry at least two (meth)acrylate functions, preference is given to using one or more compounds from the list encompassing difunctional aliphatic (meth)acrylates such as 1,3-propanediol di(meth)acrylate, 1,4-butanediol di(meth)acrylate, 1,6-hexanediol di(meth)acrylate, 1,5-neopentyl di(meth)acrylate, dipropylene glycol di(meth)acrylate, tricyclodecanedimethylol di(meth)acrylate, cyclohexanedimethanol di(meth)acrylate, trifunctional aliphatic (meth)acrylates such as trimethylolpropane tri(meth)acrylate, tetrafunctional aliphatic (meth)acrylates such as ditrimethylolpropane tetra(meth)acrylate or ditrimethylolpropane tetra(meth)acrylate, pentafunctional aliphatic (meth)acrylates such as dipentaerythritol monohydroxypenta(meth)acrylate, hexafunctional aliphatic (meth)acrylates such as dipentaerythritol hexa(meth)acrylate. Furthermore, if compounds with higher functionalization are used, it is possible to utilize aliphatic or aromatic, more particularly ethoxylated and propoxylated, polyether (meth)acrylates having in particular two, three, four or six (meth)acrylate functions such as ethoxylated bisphenol A di(meth)acrylate, polyethylene glycol di(meth)acrylate, propoxylated trimethylolpropane tri(meth)acrylate, propoxylated glycerol tri(meth)acrylate, propoxylated neopentylglycerol di(meth)acrylate, ethoxylated trimethylol tri(meth)acrylate, ethoxylated trimethylolpropane di(meth)acrylate, ethoxylated trimethylolpropane tri(meth)acrylate, tetraethylene glycol di(meth)acrylate, ethoxylated neopentyl glycol di(meth)acrylate, propoxylated pentaerythritol tri(meth)acrylate, dipropylene glycol di(meth)acrylate, ethoxylated trimethylolpropane methyl ether di(meth)acrylate, aliphatic or aromatic polyester (meth)acrylates having in particular two, three, four or six (meth)acrylate functions, aliphatic or aromatic urethane (meth)acrylates having in particular two, three, four or six (meth)acrylate functions, aliphatic or aromatic epoxy (meth)acrylates having in particular two, three, four or six (meth)acrylate functions.

The adhesive formulation further comprises at least one kind of photoinitiator for the radical curing of the reactive resins. Advantageous photoinitiators are those which exhibit absorption at less than 350 nm and advantageously at greater than 250 nm. Initiators which absorb above 350 nm, in the violet light range, for example, can likewise be used. Suitable representatives of photoinitiators for radical curing are type-I photoinitiators, in other words so-called α-splitters such as benzoin derivatives and acetophenone derivatives, benzyl ketals or acylphosphine oxides, type-II photoinitiators, in other words so-called hydrogen abstractors such as benzophenone derivatives and certain quinones, diketones, and thioxanthones. Furthermore, triazine derivatives may be used in order to initiate radical reactions.

Photoinitiators of type I which can be used advantageously include, for example, benzoin, benzoin ethers such as, for example, benzoin methyl ether, benzoin isopropyl ether, benzoin butyl ether, benzoin isobutyl ether, methylolbenzoin derivatives such as methylolbenzoin propyl ether, 4-benzoyl-1,3-dioxolane and its derivatives, benzyl ketal derivatives such as 2,2-dimethoxy-2-phenylacetophenone or 2-benzoyl-2-phenyl-1,3-dioxolane, α,α-dialkoxyacetophenones such as α,α-dimethoxyacetophenone and α,α-diethoxyacetophenone, α-hydroxyalkylphenones such as 1-hydroxycyclohexyl phenyl ketone, 2-hydroxy-2-methyl-1-phenylpropanone and 2-hydroxy-2-methyl-1-(4-isopropylphenyl)propanone, 4-(2-hydroxyethoxyl)phenyl-2-hydroxy-2-methyl-2-propanone and its derivatives, α-aminoalkylphenones such as 2-methyl-1-[4-(methylthio)phenyl]-2-morpholinopropan-2-one and 2-benzyl-2-dimethylamino-1-(4-morpholinophenyl)butan-1-one, acylphosphine oxides such as 2,4,6-trimethylbenzoyldiphenylphospine oxide and ethyl 2,4,6-trimethylbenzoylphenylphosphinate, and O-acyl α-oximino ketones.

Photoinitiators of type II which can be used advantageously include, for example, benzophenone and its derivatives such as 2,4,6-trimethylbenzophenone or 4,4′-bis(dimethylamino)benzophenone, thioxanthone and its derivatives such as 2-isopropylthioxanthone and 2,4-diethylthioxanthone, xanthone and its derivatives, and anthraquinone and its derivatives.

Type-II photoinitiators are used with particular advantage in combination with nitrogen-containing coinitiators, referred to as amine synergists. In the sense of this invention, preference is given to using tertiary amines. Furthermore, hydrogen atom donors are employed advantageously in combination with type-II photoinitiators. Examples of such donors are substrates which contain amino groups. Examples of amine synergists are methyldiethanolamine, triethanolamine, ethyl 4-(dimethylamino)benzoate, 2-n-butoxyethyl 4-(dimethylamino)benzoate, 2-ethylhexyl 4-(dimethylamino)benzoate, 2-(dimethylaminophenyl)ethanone, and also—unsaturated and copolymerizable therewith—tertiary amines, (meth)acrylated amines, unsaturated, amine-modified oligomers and polymers based on polyester or on polyether, and amine-modified (meth)acrylates.

Use may also be made of polymerizable photoinitiators of type I and/or type II.

In the sense of these inventions, it is also possible to employ any desired combinations of different kinds of type-I and/or type-II photoinitiators.

Very preferred as reactive systems as well are epoxy resins and/or epoxy resin mixtures, which may be cured UV-cationically in combination with photoinitiators, or may be cured thermally cationically in combination with thermal initiators.

The adhesive of the invention accordingly and very preferably includes at least one kind of reactive resin based on a cyclic ether for the radiative and optionally thermal crosslinking, with a softening temperature below the laminating temperature.

The reactive resins based on cyclic ethers are more particularly epoxides, in other words compounds which carry at least one oxirane group, or oxetanes. They may be aromatic or, more particularly, aliphatic or cycloaliphatic in nature.

Useful reactive resins may be monofunctional, difunctional, trifunctional, tetrafunctional or of higher functionality, up to polyfunctionality, in form, with the functionality pertaining to the cyclic ether group.

Examples, without any intention to impose a restriction, are 3,4-epoxycyclohexylmethyl 3′,4′-epoxycyclohexanecarboxylate (EEC) and derivatives, dicyclopentadiene dioxide and derivatives, 3-ethyl-3-oxetanemethanol and derivatives, diglycidyl tetrahydrophthalate and derivatives, diglycidyl hexahydrophthalate and derivatives, 1,2-ethane diglycidyl ether and derivatives, 1,3-propane diglycidyl ether and derivatives, 1,4-butanediol diglycidyl ether and derivatives, higher 1,n-alkane diglycidyl ethers and derivatives, bis[(3,4-epoxycyclohexyl)methyl]adipate and derivatives, vinylcyclohexyl dioxide and derivatives, 1,4-cyclohexanedimethanol bis(3,4-epoxycyclohexanecarboxylate) and derivatives, diglycidyl 4,5-epoxytetrahydrophthalate and derivatives, bis[1-ethyl(3-oxetanyl)methyl]ether and derivatives, pentaerythrityl tetraglycidyl ether and derivatives, bisphenol A diglycidyl ether (DGEBA), hydrogenated bisphenol A diglycidyl ether, bisphenol F diglycidyl ether, hydrogenated bisphenol F diglycidyl ether, epoxyphenol novolaks, hydrogenated epoxyphenol novolaks, epoxycresol novolaks, hydrogenated epoxycresol novolaks, 2-(7-oxabicyclospiro(1,3-dioxane-5,3′-(7-oxabicyclo[4.1.0]heptane)), 1,4-bis-((2,3-epoxypropoxy)methyl)cyclohexane.

Reactive resins can be used in their monomeric form or else dimeric form, trimeric form, etc., up to and including their oligomeric form.

Mixtures of reactive resins with one another or else with other coreactive compounds such as alcohols (monofunctional or polyfunctional) or vinyl ethers (monofunctional or polyfunctional) are likewise possible.

The adhesive formulation then additionally comprises at least one kind of photoinitiator for the cationic curing of the reactive resins. Among the initiators for cationic UV curing, more particularly, sulfonium-, iodonium- and metallocene-based systems are usable.

As examples of sulfonium-based cations, reference is made to the details in U.S. Pat. No. 6,908,722 B1 (especially columns 10 to 21).

Examples of anions which serve as counterions to the abovementioned cations include tetrafluoroborate, tetraphenylborate, hexafluorophosphate, perchlorate, tetrachloro-ferrate, hexafluoroarsenate, hexafluoroantimonate, pentafluorohydroxyantimonate, hexachloro-antimonate, tetrakispentafluorophenylborate, tetrakis(pentafluoromethyl-phenyl)borate, bi(trifluoromethylsulfonyl)amide and tris(trifluoromethylsulfonyl)methide. Additionally conceivable as anions, especially for iodonium-based initiators, are also chloride, bromide or iodide, although preference is given to initiators essentially free of chlorine and bromine.

More specifically, the usable systems include
sulfonium salts (see, for example, U.S. Pat. No. 4,231,951 A, U.S. Pat. No. 4,256,828 A, U.S. Pat. No. 4,058,401 A, U.S. Pat. No. 4,138,255 A and US 2010/063221 A1) such as triphenylsulfonium hexafluoroarsenate, triphenylsulfonium hexafluoroborate, triphenylsulfonium tetra-fluoroborate, triphenylsulfonium tetrakis(pentafluorobenzyl)borate, methyldiphenyl-sulfonium tetrafluoroborate, methyldiphenylsulfonium tetrakis(pentafluorobenzyl)-borate, dimethylphenylsulfonium hexafluorophosphate, triphenylsulfonium hexa-fluorophosphate, triphenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfonium tetrafluoroborate, 4-butoxy-phenyldiphenylsulfonium tetrakis(pentafluorobenzyl)borate, 4-chlorophenyldiphenyl-sulfonium hexafluoroantimonate, tris(4-phenoxyphenyl)-sulfonium hexafluoro-phosphate, di(4-ethoxyphenyl)methylsulfonium hexafluoroarsenate, 4-acetylphenyl-diphenylsulfonium tetrafluoroborate, 4-acetylphenyldiphenylsulfonium tetrakis(penta-fluorobenzyl)borate, tris(4-thiomethoxyphenyl)sulfonium hexafluorophosphate, di(methoxysulfonylphenyl)-methylsulfonium hexafluoroantimonate, di(methoxy-naphthyl)methylsulfonium tetrafluoroborate, di(methoxynaphthyl)methylsulfonium tetrakis(pentafluorobenzyl)-borate, di(carbomethoxyphenyl)methylsulfonium hexa-fluorophosphate, (4-octyloxyphenyl)diphenylsulfonium tetrakis(3,5-bis(trifluoro-methyl)phenyl)borate, tris[4-(4-acetylphenyl)thiophenyl]sulfonium tetrakis(pentafluoro-phenyl)borate, tris(dodecylphenyl)sulfonium tetrakis(3,5-bis(trifluoromethyl)-phenyl)borate, 4-acetamidophenyldiphenylsulfonium tetrafluoroborate, 4-acetamidophenyldiphenylsulfonium tetrakis(pentafluorobenzyl)borate, dimethyl-naphthylsulfonium hexafluorophosphate, trifluoromethyldiphenylsulfonium tetrafluoroborate, trifluoromethyldiphenylsulfonium tetrakis(pentafluorobenzyl)borate, phenylmethyl-benzylsulfonium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(penta-fluorobenzyl)borate, 5-methyl-10-oxothianthrenium tetrafluoroborate, 5-methyl-10-oxothianthrenium tetrakis(pentafluorobenzyl)borate and 5-methyl-10,10-dioxothianthrenium hexafluorophosphate,
iodonium salts (see, for example, U.S. Pat. No. 3,729,313 A, U.S. Pat. No. 3,741,769 A, U.S. Pat. No. 4,250,053 A, U.S. Pat. No. 4,394,403 A and US 2010/063221 A1) such as diphenyliodonium tetrafluoroborate, di(4-methylphenyl)iodonium tetrafluoroborate, phenyl-4-methylphenyliodonium tetra-fluoroborate, di(4-chlorophenyl)iodonium hexafluorophosphate, dinaphthyliodonium tetrafluoroborate, di(4-trifluoromethylphenyl)iodonium tetrafluoroborate, diphenyl-iodonium hexafluorophosphate, di(4-methylphenyl)iodonium hexafluorophosphate, diphenyliodonium hexafluoroarsenate, di(4-phenoxyphenyl)iodonium tetrafluoroborate, phenyl-2-thienyliodonium hexafluorophosphate, 3,5-dimethylpyrazolyl-4-phenyl-iodonium hexafluorophosphate, diphenyliodonium hexafluoroantimonate, 2,2′-diphenyliodonium tetrafluoroborate, di(2,4-dichlorophenyl)-iodonium hexafluoro-phosphate, di(4-bromophenyl)iodonium hexafluorophosphate, di(4-methoxyphenyl)-iodonium hexafluorophosphate, di(3-carboxyphenyl)iodonium hexafluorophosphate, di(3-methoxycarbonylphenyl)iodonium hexafluorophosphate, di(3-methoxysulfonyl-phenyl)-iodonium hexafluorophosphate, di(4-acetamidophenyl)iodonium hexafluoro-phosphate, di(2-benzothienyl)iodonium hexafluorophosphate, diaryliodonium tristrifluoromethylsulfonylmethide such as diphenyliodonium hexafluoroantimonate, diaryliodonium tetrakis(pentafluorophenyl)borate such as diphenyliodonium tetrakis-(pentafluorophenyl)borate, (4-n-desiloxyphenyl)phenyliodonium hexafluoroantimonate, [4-(2-hydroxy-n-tetradesiloxy)phenyl]phenyliodonium hexafluoroantimonate, [4-(2-hydroxy-n-tetradesiloxy)phenyl]phenyliodonium trifluorosulfonate, [4-(2-hydroxy-n-tetradesiloxy)phenyl]phenyliodonium hexafluorophosphate, [4-(2-hydroxy-n-tetradesiloxy)phenyl]phenyliodonium tetrakis(pentafluorophenyl)borate, bis(4-tert-butylphenyl)iodonium hexafluoroantimonate, bis(4-tert-butylphenyl)iodonium hexa-fluorophosphate, bis(4-tert-butylphenyl)iodonium trifluorosulfonate, bis(4-tert-butyl-phenyl)iodonium tetrafluoroborate, bis(dodecylphenyl)iodonium hexafluoroantimonate, bis(dodecylphenyl)iodonium tetrafluoroborate, bis(dodecylphenyl)iodonium hexa-fluorophosphate, bis(dodecylphenyl)iodonium trifluoromethylsulfonate, di(dodecyl-phenyl)iodonium hexafluoroantimonate, di(dodecylphenyl)iodonium triflate, diphenyl-iodonium bisulfate, 4,4′-dichlorodiphenyliodonium bisulfate, 4,4′-dibromo-diphenyliodonium bisulfate, 3,3′-dinitrodiphenyliodonium bisulfate, 4,4′-dimethyl-diphenyliodonium bisulfate, 4,4′-bis(succinimidodiphenyl)iodonium bisulfate, 3-nitrodiphenyliodonium bisulfate, 4,4′-dimethoxy-diphenyliodonium bisulfate, bis(dodecylphenyl)iodonium tetrakis(pentafluorophenyl)borate, (4-octyloxyphenyl)-phenyliodonium tetrakis(3,5-bis-trifluoromethylphenyl)borate and (tolylcumyl)iodonium tetrakis(pentafluorophenyl)borate,
   and
ferrocenium salts (see, for example, EP 542 716 B1) such as η₅-(2,4-cyclopentadien-1-yl)-[(1,2,3,4,5,6,9)-(1-methylethyl)benzene]iron.

Examples of commercialized photoinitiators are Cyracure UVI-6990, Cyracure UVI-6992, Cyracure UVI-6974 and Cyracure UVI-6976 from Union Carbide, Optomer SP-55, Optomer SP-150, Optomer SP-151, Optomer SP-170 and Optomer SP-172 from Adeka, San-Aid SI-45L, San-Aid SI-60L, San-Aid SI-80L, San-Aid SI-100L, San-Aid SI-110L, San-Aid SI-150L and San-Aid SI-180L from Sanshin Chemical, SarCat CD-1010, SarCat CD-1011 and SarCat CD-1012 from Sartomer, Degacure K185 from Degussa, Rhodorsil Photoinitiator 2074 from Rhodia, CI-2481, CI-2624, CI-2639, CI-2064, CI-2734, CI-2855, CI-2823 and CI-2758 from Nippon Soda, Omnicat 320, Omnicat 430, Omnicat 432, Omnicat 440, Omnicat 445, Omnicat 550, Omnicat 550 BL and Omnicat 650 from IGM Resins, Daicat II from Daicel, UVAC 1591 from Daicel-Cytec, FFC 509 from 3M, BBI-102, BBI-103, BBI-105, BBI-106, BBI-109, BBI-110, BBI-201, BBI, 301, BI-105, DPI-105, DPI-106, DPI-109, DPI-201, DTS-102, DTS-103, DTS-105, NDS-103, NDS-105, NDS-155, NDS-159, NDS-165, TPS-102, TPS-103, TPS-105, TPS-106, TPS-109, TPS-1000, MDS-103, MDS-105, MDS-109, MDS-205, MPI-103, MPI-105, MPI-106, MPI-109, DS-100, DS-101, MBZ-101, MBZ-201, MBZ-301, NAI-100, NAI-101, NAI-105, NAI-106, NAI-109, NAI-1002, NAI-1003, NAI-1004, NB-101, NB-201, NDI-101, NDI-105, NDI-106, NDI-109, PAI-01, PAI-101, PAI-106, PAI-1001, PI-105, PI-106, PI-109, PYR-100, SI-101, SI-105, SI-106 and SI-109 from Midori Kagaku, Kayacure PCI-204, Kayacure PCI-205, Kayacure PCI-615, Kayacure PCI-625, Kayarad 220 and Kayarad 620, PCI-061T, PCI-062T, PCI-020T, PCI-022T from Nippon Kayaku, TS-01 and TS-91 from Sanwa Chemical, Deuteron UV 1240 from Deuteron, Tego Photocompound 1465N from Evonik, UV 9380 C-D1 from GE Bayer Silicones, FX 512 from Cytec, Silicolease UV Cata 211 from Bluestar Silicones and Irgacure 250, Irgacure 261, Irgacure 270, Irgacure PAG 103, Irgacure PAG 121, Irgacure PAG 203, Irgacure PAG 290, Irgacure CGI 725, Irgacure CGI 1380, Irgacure CGI 1907 and Irgacure GSID 26-1 from BASF.

Photoinitiators are employed uncombined or as a combination of two or more photoinitiators.

Advantageous photoinitiators are those which exhibit absorption at less than 350 nm and advantageously at greater than 250 nm. Initiators which absorb above 350 nm, in the violet light range, for example, can likewise be employed. Sulfonium-based photoinitiators are employed with particular preference, since they have advantageous UV absorption characteristics.

Additionally as photosensitizers it is possible for diphenolmethanone and derivatives and also 4-isopropyl-9-thioxanthenone and derivatives to be used.

Combinations of different reactive systems may also be used.

Likewise utilizable are thiol-ene systems, especially if a diene rubber is employed as elastomer component.

In adhesives of the invention there may also be further constituents such as additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants.

### Optionally Employable Carriers:

If a carrier is used, suitability is possessed by all of the systems known according to the prior art. Polyesters (PET) and polypropylene are especially suitable examples. Flexible carriers according to WO 2011/134782 may likewise be employed. For many applications, transparent carriers are appropriate.

The optionally employable carrier film may be produced in principle using any film-forming and/or extrudable polymers. In this regard see, for example, the compilation by Nentwig [J. Nentwig, Kunststofffolien [plastics films], chapter 5, 2nd edn., 2000, C. Hanser, Munich]. One preferred version uses polyolefins. Preferred polyolefins are prepared from ethylene, propylene, butylene and/or hexylene, it being possible in each case for the pure monomers to be polymerized, or mixtures of the stated polymers are copolymerized. Through the polymerization process and through the selection of the monomers it is possible to control the physical and mechanical properties of the polymer film, such as the softening temperature and/or the tensile strength, for example. Another preferred version of this invention uses polyvinyl acetates. Polyvinyl acetates may include not only vinyl acetate but also vinyl alcohol as comonomer, and the free alcohol fraction can be varied within wide limits. A further preferred version of this invention uses polyesters as carrier film. In one particularly preferred version of this invention, polyesters based on, for example, polyethylene terephthalate (PET) or polybutylene terephthalate (PBT) are used. In another preferred version of this invention, polyvinyl chlorides (PVC) are used as film. To raise the temperature stability, the polymer constituents present in these films may be prepared using stiffening comonomers. Furthermore, the films may be radiation-crosslinked, in order to obtain a similar improvement in properties. Where PVC is employed as raw film material, it may optionally comprise plastifying components (plasticizers). Also possible is the utilization of other halogenated hydrocarbons as film base material, such as polyvinylidene chloride or fluorinated systems, for example. A further preferred version of this invention uses polyamides to produce films. The polyamides may consist of a dicarboxylic acid and a diamine or of a plurality of dicarboxylic acids and diamines. Besides dicarboxylic acids and diamines, amines and carboxylic acids with higher functionality may also be used, both alone and in combination with the aforementioned dicarboxylic acids and diamines. For the stiffening of the film, preference is given to using cyclic, aromatic or heteroaromatic starting monomers. A further preferred version of this invention uses polymethacrylates to produce films. In this case the glass transition temperature of the film can be controlled through the choice of the monomers (methacrylates and in some cases acrylates as well). Moreover, the polymethacrylates may also include additives, in order, for example, to raise the flexibility of the film or to raise or lower the glass transition temperature, or to minimize the formation of crystalline segments. A further preferred version of this invention uses polycarbonates for the production of films. Furthermore, in another version of this invention, polymers and copolymers based on vinyl aromatics and on vinyl heteroaromatics may be employed for the purpose of producing the optionally employable carrier film.

The optionally employable carrier film may optionally be in monoaxially oriented, biaxially oriented or unoriented form. To produce a material in film form it may be appropriate to add additives and further components which improve the film-forming properties, reduce the tendency toward formation of crystalline segments and/or specifically improve or even, where appropriate, impair the mechanical properties. As further additives for optional use it is possible for aging inhibitors, light stabilizers such as, in particular, UV protectants, antioxidants, further stabilizers, flame retardants, pigments, dyes and/or expandants to be included. The optionally employable carrier film may itself be employed as a single-layer construction, or else as a multilayer assembly, obtained for example by coextrusion. Furthermore, on one and/or both sides, the carrier film may also have been pretreated and/or providing with a functional coat. Where both sides have been pretreated and/or coated, the nature and/or extent of the pretreatment and/or coating may be the same or different. Such pretreatment and/or coating may result, for example, in improved anchorage of one or both layers of adhesive. For this purpose it is particularly advantageous if one or both sides of the carrier film are pretreated with one or different kinds of primer and/or if one or both sides of the carrier film are pretreated by corona treatment and/or flaming and/or plasma treatment and/or other methods of surface activation. For the purposes of this invention, the optionally employable carrier film may be transparent and colorless or else transparent and colored. It is also in accordance with the invention for the film to be nontransparent and also to be white, gray, black or colored.

The optionally employable carrier moreover may be more flexible than aforementioned materials and may in particular have an elasticity modulus of less than 1 GPa. With regard to the selection of materials for such carriers, there are no particular restrictions in place. Appropriate base material for such carriers includes thermoplastic and non-thermoplastic elastomers. The elastomers preferably have a high elastic fraction. This fraction is preferably at least 80%, preferably at least 90%, although a viscoelastic behavior with a relatively low elastic fraction is also possible. The elastic fraction of the double-sidedly pressure-sensitively adhesive products is likewise preferably at least 80%, very preferably at least 90%, although here again a viscoelastic behavior with relatively low elastic fraction is possible.

The base material for flexible carriers has at least one phase which has a softening temperature of below 25° C., preferably of below 0° C., referred to as the elastomer phase or soft phase. Very preferably this phase is present at more than 25 wt % and, by virtue of mixing or chemical incorporation, is part of the base material of the carrier layer.

The group of the nonthermoplastic elastomers which can be used in the carrier comprises, in particular, chemically crosslinked (co)polymers. Appropriate modes of crosslinking include all of the approaches known to the skilled person for the production of elastomers/rubbers. Examples cited include covalent crosslinking via reactions between functional groups which are present in the (co)polymers and crosslinkers. Available to the developer for this purpose are all of the crosslinking approaches from the chemistry of rubbers, coatings, thermosets, paints, and adhesives. It is advantageous to use polyfunctional crosslinker molecules—bifunctional, for example. These molecules may be isocyanates, epoxides, silanes, anhydrides, aziridines or melamines. Furthermore, peroxide-based crosslinkers can be used, and vulcanizing systems. G. Auchter et al. indicate a series of crosslinking approaches which can also be used advantageously for the carrier for the purposes of this invention (G. Auchter et al. in Handbook of Pressure-Sensitive Adhesive Technology, D. Satas (ed.), 3^{rd} edn., 1999, Satas & Associates, Warwick, pp. 358-470 and literature cited therein).

Very advantageous within the group of the nonthermoplastic elastomers are chemically crosslinked (meth)acrylate copolymer-based elastomers which through appropriate choice of the (meth)acrylate monomers exhibit an inventively low softening temperature and comprise functional comonomers which are capable of a chemical reaction with crosslinkers. U.S. Pat. No. 3,038,886 indicates an example of a chemically crosslinked polyacrylate elastomer, where ethyl acrylate has been copolymerized with 2-hydroxyethyl methacrylate. 2-Hydroxyethyl methacrylate offers with the OH group a functional group via which a covalent bond is developed with a crosslinker (in this case, acid anhydride). Furthermore, coordinative (for example, forming multidentate complexes, such as metal chelates) and ionic (for example, forming ion clusters) crosslinking modes are possible, provided they have sufficient stability. Also possible are chemical crosslinking methods initiated by radiation. These include, in particular, crosslinking reactions initiated by UV rays and/or electron beams. In addition to (meth)acrylic comonomers, (meth)acrylate copolymers may also include other comonomers, especially vinylic comonomers.

The higher the degree of crosslinking, the higher, too, the modulus of elasticity for the resulting elastomers. Via the degree of crosslinking it is therefore possible to adjust the elastic properties of the nonthermoplastic elastomers in accordance with the requirements for the purposes of this invention.

As nonthermoplastic elastomers it is also advantageous to use rubber-based materials for the carrier of products of the invention, in order to realize the desired elastic properties. Although rubbers as well can be chemically crosslinked, they can also be used without additional crosslinking if their molar masses are sufficiently high (as is the case for many natural and synthetic systems). The desired elastic properties result in long-chain rubbers from the interloops, or from the interloop molar masses, which are polymer-characteristic (with regard to the approach and for a series of polymers, see L. J. Fetters et al., Macromolecules, 1994, 27, 4639-4647). Where rubber or synthetic rubber or blends produced therefrom are employed as base material for the at least one carrier layer, then the natural rubber may in principle be selected from all available grades such as, for example, crepe, RSS, ADS, TSR or CV types, depending on required level of purity and of viscosity, and the synthetic rubber or rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or from blends thereof. The mandate for the selection of such materials for carrier systems of products of the invention is agreement with the mandates concerning the optical quality in accordance with this invention.

Without wishing to be limited by this listing, the group of the thermoplastic elastomers that can be used for the carrier includes semicrystalline polymers, ionomer-containing polymers, block copolymers, and segmented copolymers. Specific examples of thermoplastic elastomers are thermoplastic polyurethanes (TPU). Polyurethanes are chemically and/or physically crosslinked polycondensates which are typically synthesized from polyols and isocyanates and which typically comprise soft segments and hard segments. The soft segments are composed, for example, of polyesters, polyethers, polycarbonates, each preferably aliphatic in nature in accordance with this invention, with polyisocyanate hard segments. Depending on the nature of the individual components and the proportions in which they are used, materials are obtainable which can be used advantageously for the purposes of this invention. Raw materials available to the formulator for this purpose are identified for example in EP 894 841 B1 and EP 1 308 492 B1. Lycra® from DuPont, Estane®, Mobay Texin®, Upjohn Pellethane® from Goodrich, and Desmopan® and Elastollan® from Bayer may find use. It is also possible to use thermoplastic polyetherester elastomers such as Hytrel® from DuPont, Arnitel® from DSM, Ectel® from Eastman, Pipiflex® from Enichem, Lomod® from General Electric, Riteflex® from Celanese, Zeospan® from Nippon Zeon, Elitel® from Elana, and Pelprene® from Toyobo. Use may be made, furthermore, of polyamides such as polyesteramides, polyetheresteramides, polycarbonateesteramides and polyether-block-amides, from Dow Chemical and Atofina, for example. Also suitable for use are halogenated polyvinyls such as, in particular, soft PVC. It is further possible to employ ionomer-based thermoplastic elastomers such as Surlyn® from DuPont, for example.

Further specific examples of thermoplastic elastomers which can be used in carriers are semicrystalline polymers. Polyolefins are particularly appropriate in this context. Preferred polyolefins are prepared from ethylene, propylene, butylene and/or hexylene, with the pure monomers able to be polymerized in each case, or mixtures of the stated monomers and further monomers are copolymerized. Through the polymerization process and through the selection of the monomers it is possible to control the physical and mechanical properties of the polymeric film, such as the softening temperature and/or the stretchability, for example, and especially the modulus of elasticity. Examples of raw materials which can be used are polyolefins such as ethylene-vinyl acetate (EVA), ethylene-acrylate (EA), ethylene-methacrylate (EMA), low density polyethylene (PE-LD), linear low density polyethylene (PE-LLD), very low density linear polyethylene (PE-VLD), polypropylene homopolymer (PP-H), and polypropylene copolymer (PP-C) (impact or random). Other examples of raw materials for the carrier are soft polyethylene elastomers such as Affinity™ (Dow Chemical), Engage™ (Dow Chemical), Exact™ (Dex Plastomers), Tafmer™ (Mitsui Chemicals), soft polypropylene copolymers such as Vistamaxx™ (Exxon Mobil), Versify™ (Dow Chemical), which have a low melting point as a result of a random structure, and elastomeric heterophase polyolefins (for example with a block structure) such as Infuse™ (Dow Chemical), Hifax™ (Lyondell Basell), Adflex™ (Lyondell Basell) or Softell™ (Lyondell Basell).

In one preferred embodiment of the invention, carriers used are commercially available stretch films or films of the kind employed as “cling films”, being employed either alone or in combination with further films and/or layers.

Thermoplastic elastomers which can be used with particular advantage for the carrier are block copolymers. Here, individual polymer blocks are linked covalently with one another. Block linkage may be present in a linear form, or else in a star-shaped or graft copolymer variant. One example of an advantageously usable block copolymer is a linear triblock copolymer whose two terminal blocks (known as hard blocks) have a softening temperature of at least 40° C., preferably at least 70° C., and whose middle block (known as soft blocks) has a softening temperature of not more than 0° C., preferably not more than −30° C. Higher block copolymers, tetrablock copolymers for instance, can likewise be employed. It is important that in the block copolymer there are at least two identical or different polymer blocks which have a softening temperature in each case of at least 40° C., preferably at least 70° C. (hard blocks), and which are separated from one another in the polymer chain by at least one polymer block having a softening temperature of not more than 0° C., preferably not more than −30° C. (soft blocks). Examples of polymer blocks are polyethers such as, for example, polyethylene glycol, polypropylene glycol or polytetrahydrofuran, polydienes, such as, for example, polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-α-methylstyrene, polyalkyl vinyl ethers, polyvinyl acetate, and polymer blocks of α,β-unsaturated esters such as, more particularly, acrylates or methacrylates. The skilled person knows of corresponding softening temperatures. Alternatively he or she looks them up, for example, in the Polymer Handbook [J. Brandrup, E. H. Immergut, E. A. Grulke (eds.), Polymer Handbook, 4^{th} edn. 1999, Wiley, New York]. Polymer blocks may be composed of copolymers.

Specific examples of block copolymers which can be used with particular advantage as thermoplastic elastomers for the carriers are triblock copolymers consisting of polystyrene end blocks and polyisoprene or polybutadiene middle blocks. These middle blocks may be in partly or fully hydrogenated form. Such materials are available for example from a series of manufacturers. Examples are Kraton™ from Kraton, Vector® from Dexco, Taipol® from TSRC, Europrene® from Polimeri Europa, Baling® from Sinopec, Globalprene® from LCY, Quintac® from Nippon Zeon, Calprene® and Solprene® from Dynasol, Tuftec® from Asahi, Septon® from Kuraray, Enprene® from Enchuan, Dynaron® from JSR, Finaprene® from Atofina, Coperflex® from Petroflex, and Styroflex® and Styrolux® from BASF. It is also possible to use triblock copolymers consisting of polystyrene end blocks and polyisobutylene middle blocks, of the kind available as SIBStar® from Kaneka. Also useful with great advantage are triblock copolymers consisting of polymethyl methacrylate end blocks and polybutyl acrylate middle blocks, of the kind obtainable as LA-Polymer® from Kuraray or else block copolymers consisting of polystyrene blocks and poly(meth)acrylate blocks.

In order to produce a carrier it may be appropriate here as well to add additives and further components which enhance the film-forming properties, reduce the tendency toward formation of crystalline segments, adjust the softening temperatures of the soft and/or hard phases, and/or deliberately enhance or else, optionally, impair the mechanical properties. As plasticizers which can optionally be used it is possible to use all of the plasticizing substances known from the technology of self-adhesive tape. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. It is possible, moreover, to use antistats, antiblocking agents, antioxidants, light stabilizers, and lubricants (see, for example, J. Murphy, The Additives for Plastics Handbook, 1996, Elsevier, Oxford, pp. 2-9).

Combinations of different modes of crosslinking, as stated for thermoplastic and nonthermoplastic elastomers, and also other modes of crosslinking known to the skilled person, are likewise encompassed by the present invention in relation to the design of the carriers of double-sidedly pressure-sensitively adhesive products of the invention.

### Product Constructions:

In the case of carrier-containing product constructions, at least one layer of adhesive is in accordance with the invention. The other layer of adhesive may be selected from any desired layers from the prior art. In the laminating process, noninventive layer adhesive, where present, is laminated first of all to substrate A. The layer of adhesive of the invention, which at this stage is still unbonded, is then utilized for the lamination of the second rigid substrate.

The thickness of layers of adhesive is such that the overall layer thickness of the double-sided adhesive product is at most 80 μm, preferably at most 60 μm. Where carrier layers are employed, the layers of adhesive are selected in terms of their thickness such that the overall layer thickness of the double-sided adhesive product is at most 80 μm, preferably at most 60 μm. 50 μm and 25 μm are examples of adhesive-layer thicknesses for carrier-free product constructions, in other words adhesive transfer tapes. 25 μm and 15 μm are examples of adhesive layer thicknesses for carrier-containing product constructions.

Optionally employable carriers are preferably as thin as possible given considerations of handleability and processing. The carrier thickness is not more than 50 μm, preferably not more than 36 μm, very preferably below 25 μm (e.g., 12 μm). Carrier films with a high elasticity modulus (especially >1 GPa) are selected preferably in the thin thickness range (maximum 36 μm, very preferably maximum 25 μm).

### Laminating Operation (Step 1):

In this step the double-sided adhesive product is laminated to a first rigid substrate (substrate A). Suitable for this purpose are all laminators which are capable of laminating substrate pairs together, where one of the pair is rigid and one is flexible, such laminators being referred to as “roll-to-sheet” or “flex-to-rigid” or “film-to-sheet” or “film-to-panel” laminators. Roll-based laminators are common (see JP H07-105791, for example).

### Laminating Operating (Step 2):

In this step the substrate A furnished with the double-sided adhesive product is laminated together with the second rigid substrate (substrate B). Suitable for this purpose are all laminators which are capable of laminating substrate pairs together, of which both are rigid, such laminators being referred to as “sheet-to-sheet” or “rigid-to-rigid” or “panel-to-panel” laminators. Here, in particular, devices based on a vacuum chamber are employed. Common devices are those in which the rigid substrates are brought into contact at an angle of 0°, the substrates thus being disposed in parallel (see JP 2009-294551, for example). Devices of this kind are employed with preference for the purposes of this invention. However, devices with holding plates angled relative to one another are also known (U.S. Pat. No. 7,566,254). In processes of this kind it is also possible to operate under ambient pressure.

Also available are devices in which both laminating steps (step 1 and step 2) can be carried out.

The laminating step is carried out preferably on a machine basis and in particular in an automatable procedure.

### Autoclaving Operation:

Many laminating operations may be followed by an autoclaving operation, which optimizes the wetting of the layers of adhesive on the substrates. An autoclave is operated at elevated pressure (up to 6 bar, for example) and at moderately elevated temperature (not more than 75° C.) for a very short time (for example less than 1 hour or even less than 30 minutes).

### Use

The laminate of the invention and also the process for producing the laminate are used preferably in or for the encapsulation of optoelectronic arrangements.

Arrangements of this kind encompass inorganic or organic electronic structures, examples being organic, organometallic or polymeric semiconductors or else combinations thereof. Depending on the desired application, the products in question are rigid or flexible in form, there being an increase in demand for flexible arrangements. Such arrangements are frequently produced by printing techniques such as relief, gravure, screen or planographic printing or else what is called “nonimpact printing” such as, for instance, thermal transfer printing, inkjet printing or digital printing. In many cases, however, vacuum techniques are also used, such as chemical vapor deposition (CVD), physical vapor deposition (PVD), plasma-enhanced chemical or physical deposition techniques (PECVD), sputtering, (plasma) etching or vapor coating, for example. Patterning takes place generally through masks.

Examples of optoelectronic applications that are already commercially available or are of interest in terms of their market potential in this case include electrophoretic or electrochromic constructions or displays, organic or polymeric light-emitting diodes (OLEDs or PLEDs) in readout and display devices or as lighting, and also electroluminescent lamps, light-emitting electrochemical cells (LEECs), organic solar cells such as dye or polymer solar cells, inorganic solar cells, especially thin-film solar cells, for example those based on silicon, germanium, copper, indium, and selenium, perovskite solar cells, organic field-effect transistors, organic switching elements, organic optical amplifiers, organic laser diodes, organic or inorganic sensors or else organic- or inorganic-based RFID transponders.

Many electronic arrangements—especially where organic materials are used—are sensitive to water vapor. During the lifetime of the electronic arrangements, therefore, protection by encapsulation is needed, since otherwise the performance tails off over the period of use.

### Example 1

### Inventive

A 50 μm adhesive transfer tape (single-layer adhesive film) was produced. For this purpose, 400 g of a polystyrene-block-polyisobutylene block copolymer from Kaneka (Sibstar 62M), 380 g of a hydrocarbon tackifier resin from Eastman (Regalite R1090), and 200 g of a liquid epoxy resin (HBE-100) from ECEM were dissolved in a mixture of toluene (300 g), acetone (150 g), and special-boiling-point spirit 60/95 (550 g). The solution was subsequently admixed with 40 g of triarylsulfonium hexafluoroantimonate as photoinitiator (purchased from Sigma Aldrich). The photoinitiator was in the form of a 50 wt % strength solution in propylene carbonate.

A doctor blade process was used to coat the formulation from solution onto a siliconized PET liner, which was dried at 120° C. for 15 minutes to give a thickness of 50 μm for the layer of adhesive. The specimen was lined with a further ply of a siliconized but more readily releasing PET liner.

This adhesive transfer tape film was used to produce a glass/glass assembly.

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated glass substrate (float glass with a thickness of 2 mm and a format of 20 cm×20 cm). The glass substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated (the standard subatmospheric pressure setting of the instrument) and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was autoclaved. For this purpose, the specimen was subjected to a pressure of 5 bar for 30 minutes at a temperature of 40° C. After autoclaving, the assembly was inspected optically (for results see table 1).

### Example 2

### Inventive

A 62 μm double-sidedly adhesive film was produced. For this purpose, 333 g of a polystyrene-block-polyethylene-butylene block copolymer from Kraton (Kraton G1650), 313 g of a hydrocarbon tackifier resin from Kolon (Sukorez SU100), and 333 g of a liquid acrylate resin (SR833S) from Sartomer were dissolved in a mixture of toluene (300 g), acetone (150 g), and special-boiling-point spirit 60/95 (550 g). The solution was subsequently admixed with 20 g of Irgacure 500 as photoinitiator from BASF.

A doctor blade process was used to coat the formulation from solution onto a siliconized PET liner, which was dried at 120° C. for 15 minutes. The thickness of the layer of adhesive was 25 μm. The specimen was lined with a ply of a 12 μm transparent PET carrier. A doctor blade process was used to apply the same formulation to a further ply of a siliconized but more easily releasing PET liner, and this assembly was dried at 120° C. for 15 minutes. The thickness of this layer of adhesive was likewise 25 μm. The adhesive layer was laminated to the uncoated side of the PET carrier already furnished with a 25 μm layer of adhesive.

This double-sided adhesive film was used to produce a glass/glass assembly.

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated glass substrate (float glass with a thickness of 2 mm and a format of 20 cm×20 cm). The glass substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated (the standard subatmospheric pressure setting of the instrument) and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was autoclaved. For this purpose, the specimen was subjected to a pressure of 5 bar for 30 minutes at a temperature of 40° C. After autoclaving, the assembly was inspected optically (for results see table 1).

### Example 3

### Inventive

A 50 μm adhesive transfer tape was produced. For this purpose, 333 g of a polystyrene-block-polyethylene-butylene block copolymer from Kraton (Kraton G1650), 313 g of a hydrocarbon tackifier resin from Kolon (Sukorez SU100), and 333 g of a liquid acrylate resin (SR833S) from Sartomer were dissolved in a mixture of toluene (300 g), acetone (150 g), and special-boiling-point spirit 60/95 (550 g). The solution was subsequently admixed with 20 g of Irgacure 500 as photoinitiator from BASF.

A doctor blade process was used to coat the formulation from solution onto a siliconized PET liner, which was dried at 120° C. for 15 minutes to give a thickness of 50 μm for the layer of adhesive. The specimen was lined with a further ply of a siliconized but more readily releasing PET liner.

This adhesive transfer tape film was used to produce a glass/glass assembly.

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated glass substrate (float glass with a thickness of 2 mm and a format of 20 cm×20 cm). The glass substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated (the standard subatmospheric pressure setting of the instrument) and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was not autoclaved, instead being stored at 23° C. for 3 days. After storage, the assembly was inspected optically (for results see table 1).

### Example 4

### Inventive

A 50 μm adhesive transfer tape was produced. For this purpose, 400 g of a polystyrene-block-polyisobutylene block copolymer from Kaneka (Sibstar 62M), 380 g of a hydrocarbon tackifier resin from Eastman (Regalite R1090), and 200 g of a liquid epoxy resin (HBE-100) from ECEM were dissolved in a mixture of toluene (300 g), acetone (150 g), and special-boiling-point spirit 60/95 (550 g). The solution was subsequently admixed with 40 g of triarylsulfonium hexafluoroantimonate as photoinitiator (purchased from Sigma Aldrich). The photoinitiator was in the form of a 50 wt % strength solution in propylene carbonate.

A doctor blade process was used to coat the formulation from solution onto a siliconized PET liner, which was dried at 120° C. for 15 minutes to give a thickness of 50 μm for the layer of adhesive. The specimen was lined with a further ply of a siliconized but more readily releasing PET liner.

This adhesive transfer tape film was used to produce a glass/PC assembly (PC=polycarbonate).

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated PC substrate (thickness of 2 mm, format of 20 cm×20 cm). The PC substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated (the standard subatmospheric pressure setting of the instrument) and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was autoclaved. For this purpose, the specimen was subjected to a pressure of 5 bar for 30 minutes at a temperature of 40° C. After autoclaving, the assembly was inspected optically (for results see table 1).

### Example 5

### Comparative

A 50 μm adhesive transfer tape was produced. For this purpose, a polyacrylate with 8% acrylic acid, 46% butyl acrylate, and 46% 2-ethylhexyl acrylate and a k value according to Fikentscher of 55 was crosslinked with 0.6% aluminum chelate and coated using a doctor blade process, as a solution in acetone and benzine, onto a siliconized PET liner. This was dried at 120° C. for 15 minutes, to give a layer of adhesive having a thickness of 50 μm. The specimen was lined with a further ply of a siliconized but more easily releasing PET liner.

This adhesive transfer tape film was used to produce a glass/glass assembly.

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated glass substrate (float glass with a thickness of 2 mm and a format of 20 cm×20 cm). The glass substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated (the standard subatmospheric pressure setting of the instrument) and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was autoclaved. For this purpose, the specimen was subjected to a pressure of 5 bar for 30 minutes at a temperature of 40° C. After autoclaving, the assembly was inspected optically (for results see table 1).

### Example 6

### Comparative

A 50 μm adhesive transfer tape was produced. This was done by weighing out 450 g of a maleic anhydride-modified polystyrene-block-polyethylene-butylene block copolymer from Kraton (Kraton FG 1901), 450 g of a hydrocarbon tackifier resin from Arakawa (Arkon P100), and 100 g of Shellflex 371, a plasticizer oil from Shell. The ingredients were dissolved in a 40/40/20 mixture of toluene/benzine/isopropanol, giving a solids content of 40 wt %. Shortly before the coating operation, 5 g (solid) of aluminum acetylacetonate were added as a 10 wt % strength solution in toluene and were distributed homogeneously by stirring.

A doctor blade process was used to coat the formulation from solution onto a siliconized PET liner, which was dried at 120° C. for 15 minutes to give a thickness of 50 μm for the layer of adhesive. The specimen was lined with a further ply of a siliconized but more readily releasing PET liner.

This adhesive transfer tape film was used to produce a glass/glass assembly.

For this purpose, the more easily releasing liner was removed from a specimen of the adhesive film. With a rubber roller (laminating step 1), the adhesive film was laminated manually by the open adhesive side onto a rigid glass substrate (float glass with a thickness of 2 mm and with a format of 20 cm×20 cm). This preliminary assembly was inspected for optical properties (for results see table 1).

Laminating step 2 was carried out in a Cherusal™ TM-36GL vacuum laminator apparatus from Trimech Technology PTE Ltd. For this purpose, the laminator was first loaded with the as yet unprelaminated glass substrate (float glass with a thickness of 2 mm and a format of 20 cm×20 cm). The glass substrate was drawn up by suction, run into the laminating chamber, and drawn up by suction from the upper die plate. Thereafter the lower substrate table was loaded with the preliminary assembly (the glass substrate already equipped with adhesive film). The preliminary assembly was drawn up by suction and the second liner was removed. The lower substrate table was then run into the laminating chamber. A subatmospheric pressure of <100 Pa was generated and, when this level had been reached, the two substrates were brought into contact. Under a pressure of 40 kg, the two substrates were pressed for 10 seconds. The assembly was parted from the upper die plate, and the upper die plate was moved off. Lastly a rubber roller with a weight of 30 kg was rolled twice over the assembly at a rate of 30 mm/s. Laminating step 2 took place at 30° C. The assembly was inspected for optical properties (for results see table 1).

The assembly was autoclaved. For this purpose, the specimen was subjected to a pressure of 5 bar for 30 minutes at a temperature of 40° C. After autoclaving, the assembly was inspected optically (for results see table 1).

TABLE 1

| | Example 1 | Example 2 | Example 3 | Example 4 | Example 5 | Example 6 |
|---|---|---|---|---|---|---|
| Plasticizer | 20% | 33.3% | 33.3% | 20% | 0% | 10% |
| content | (reactive) | (reactive) | (reactive) | (reactive) | (—) | (not reactive) |
| Complex | 4000 Pa s | 7000 Pa s | 7000 Pa s | 4000 Pa s | 11 000 Pa s | 30 000 Pa s |
| viscosity (@ | | | | | | |
| laminating | | | | | | |
| temp.: 30°) | | | | | | |
| Complex | 2000 Pa s | 6000 Pa s | 6000 Pa s | 2000 Pa s | 8000 Pa s | 23 000 Pa s |
| viscosity (@ | | | | | | |
| autoclaving | | | | | | |
| temp.: 40°) | | | | | | |
| Substrate 1 | Glass | Glass | Glass | Glass | Glass | Glass |
| Substrate 2 | Glass | Glass | Glass | PC* | Glass | Glass |
| Optical | Bubble-free | Bubble-free | Bubble-free | Bubble-free | Bubble-free | Bubble-free |
| appraisal of | | | | | | |
| laminate after | | | | | | |
| laminating | | | | | | |
| step 1 | | | | | | |
| Optical | Air | Air | Air | Air | Air | Air |
| appraisal of | inclusions | inclusions | inclusions | inclusions | inclusions | inclusions |
| laminate after | | | | | | |
| laminating | | | | | | |
| step 2 | | | | | | |
| Optical | Bubble-free | Bubble-free | | Bubble-free | Air | Air |
| appraisal of | | | | | inclusions | inclusions |
| laminate after | | | | | | |
| autoclaving | | | | | | |
| Optical | | | Bubble-free | | | |
| appraisal of | | | | | | |
| laminate after | | | | | | |
| storage for 3 d | | | | | | |
| at 23° C. | | | | | | |

*PC = Polycarbonate

### Test Methods

### Test 1: Dynamic-Mechanical Analysis—Complex Viscosity:

The complex viscosity η* was used as a measure of the flow-on capacity of the adhesives, or their laminability. It was determined in oscillation in a shear stress-controlled DSR rheometer from Rheometrics. A laminate was produced from individual layers of adhesive, to give a sample thickness of 500 μm. The test specimen, with a diameter of 25 mm, was placed between two parallel plates in the rheometer. The mandated shear stress was 2500 Pa, and a measuring frequency ω of 10 rad/s was selected. A Peltier element was used to cool the sample, which was heated at a rate of 2.5 K/min from −40° C. to 130° C. The complex viscosity is calculated from the measurement data G′ (elasticity modulus or storage modulus) and G″ (viscosity modulus or loss modulus) and also from the angular frequency ω (in hertz) in accordance with

η=[(G′)²+(G″)²]^{1/2}/ω

Readoff was carried out at 30° C. (corresponding to the temperature of the second laminating step) and at 40° C. (corresponding to the autoclaving temperature).

### Test 2: Optical Appraisal (Air Inclusions):

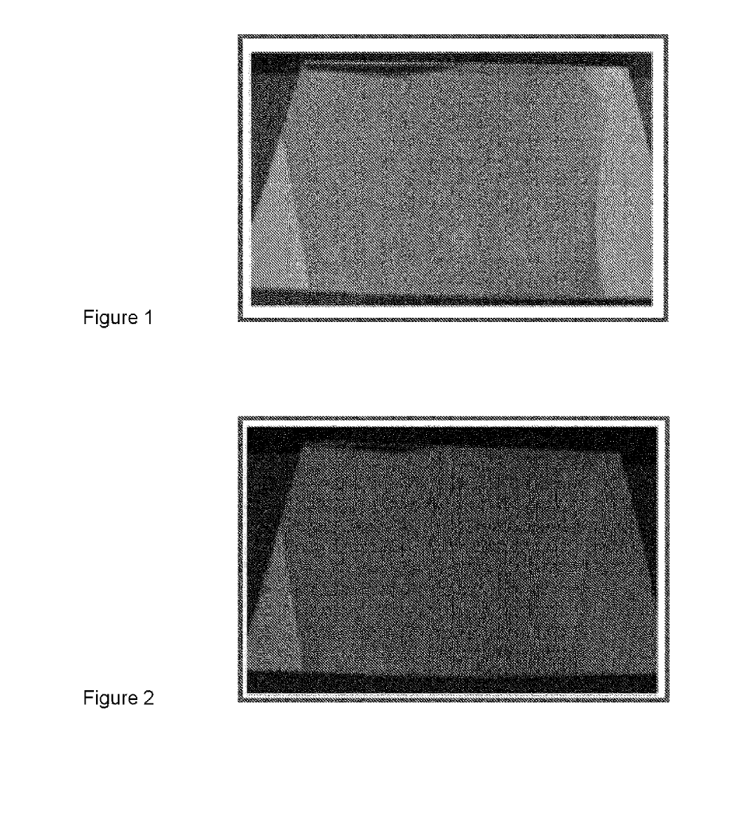

The optical appraisal was carried out in relation to any air inclusions (air bubbles). For this purpose, laminates were placed on a flat, lint-free, black background and inspected by the human eye under applied light. Distinctions were made between the assessments “air inclusions” (see FIG. 1) and “bubble-free” (see FIG. 2). The assessment “air inclusions” means that air bubbles are visible to the human eye without further assistance. The number and size of such bubbles is immaterial here. The assessment “bubble-free” means that no air bubbles are perceptible to the human eye without further assistance.

1. A laminate of two rigid substrates and one interposed adhesive film, at least one of the rigid substrates being transparent, wherein
the thickness of the adhesive film is not more than 80 μm and the adhesive film comprises at least one adhesive layer composed of an adhesive admixed with one or more plasticizers of which at least one is a reactive plasticizer,
the plasticizer fraction in the adhesive being in total at least 15 wt % and the fraction of reactive plasticizer in the adhesive being at least 5 wt %.

2. A laminate obtainable by curing the adhesive film of claim 1.

3. The laminate as claimed in claim 1, wherein the adhesive film is single-layer.

4. The laminate as claimed in claim 1, wherein the adhesive film comprises at least one carrier layer between two adhesive layers, of which at least one of the adhesive layers is a plasticizer-containing adhesive layer.

5. The laminate as claimed in claim 4, wherein the plasticizer-containing adhesive layer is in contact with the transparent rigid substrate.

6. The laminate as claimed in claim 1, wherein the adhesive of the plasticizer-containing adhesive layer is a synthetic rubber adhesive or an acrylate adhesive.

7. The laminate as claimed in claim 1, wherein the at least one reactive plasticizer is an epoxide-based or acrylate-based plasticizer.

8. The laminate as claimed in claim 1, wherein the at least one reactive plasticizer is admixed with at least one photoinitiator.

9. A process for producing a laminate of two rigid substrates and one interposed adhesive film, at least one of the rigid substrates being transparent,
comprising at least two laminating steps, the adhesive film in the first process step being laminated onto one of the two rigid substrates, and the assembly thus produced, comprising first substrate and adhesive film, in the second laminating step being laminated together by the adhesive film side to the other rigid substrate, the second laminating step being carried out at not more than 50° C., and the thickness of the adhesive film being not more than 80 μm and the adhesive film comprising at least one adhesive layer of an adhesive admixed with one or more plasticizers of which at least one is a reactive plasticizer,
the plasticizer fraction in the adhesive being in total at least 15 wt % and the fraction of reactive plasticizer in the adhesive being at least 5 wt %.

10. The process as claimed in claim 9, comprising an autoclaving step as a further process step.

11. The process as claimed in claim 9, comprising curing of the adhesive film through reaction of the reactive plasticizer.

12. The process as claimed in claim 9, wherein at least the second laminating step is carried out without a heating step in the process regime.

13. (canceled)

14. A method for the encapsulation of optoelectronic arrangements, wherein the optoelectronic arrangements are encapsulated with the laminate of claim 1.
